(19) United States
(12) Patent Application Publication
(10) Pub. No.: US 2013/0055852 A1
(43) Pub. Date: Mar. 7, 2013

(54) DEGRADABLE HIGH SHOCK IMPEDANCE MATERIAL

(71) Applicant: Zhiyue Xu, Cypress, TX (US)

(72) Inventor: Zhiyue Xu, Cypress, TX (US)

(73) Assignee: BAKER HUGHES INCORPORATED, Houston, TX (US)

(21) Appl. No.: 13/225,413

(22) Filed: Sep. 3, 2011

(51) Int. Cl. B22F 1/00; B32B 5/16; B82B 1/00

(52) U.S. Cl. 75/230; 75/228; 428/221; 428/220; 428/338; 977/779

(57) ABSTRACT

A selectively corrodible powder compact that may be used to make the components of a selectively corrodible perforating system is disclosed. The selectively corrodible powder compact includes a cellular nanomatrix comprising a nanomatrix material. The selectively corrodible powder compact also includes a plurality of dispersed particles comprising a particle core material having a density of about 7.5 g/cm³ or more, dispersed in the cellular nanomatrix. The selectively corrodible powder compact further includes a bond layer extending throughout the cellular nanomatrix between the dispersed particles.

### CROSS REFERENCE TO RELATED APPLICATIONS

This application contains subject matter related to the subject matter of co-pending applications, which are assigned to the same assignee as this application, Baker Hughes Incorporated of Houston, Tex. and are all being filed on the same date as this application. The below listed applications are hereby incorporated by reference in their entirety:

U.S. patent application Attorney Docket No. TCP4-52542-US (BAO0848US) entitled “Degradable Shaped Charge and Perforating Gun System,” and

U.S. patent application Attorney Docket No. TCP4-52543-US (BAO00849US) entitled “Method of Using a Degradable Shaped Charge and Perforating Gun System.”

### BACKGROUND

To complete a well, one or more formation zones adjacent a wellbore are perforated to allow fluid from the formation zones to flow into the well for production to the surface or to allow injection fluids to be applied into the formation zones. Perforating systems are used for the purpose, among others, of making hydraulic communication passages, called perforations, in wellbores drilled through earth formations so that predetermined zones of the earth formations can be hydraulically connected to the wellbore. Perforations are needed because wellbores are typically completed by coaxially inserting a pipe or casing into the wellbore. The casing is retained in the wellbore by pumping cement into the annular space between the wellbore and the casing to line the wellbore. The cemented casing is provided in the wellbore for the specific purpose of hydraulically isolating from each other the various earth formations penetrated by the wellbore.

Perforating systems typically comprise one or more shaped charge perforating guns strung together. A perforating gun string may be lowered into the well and one or more guns fired to create openings in the casing and/or a cement liner and to extend perforations into the surrounding formation.

Shaped charge guns known in the art for perforating wellbores typically include a shaped charge liner. A high explosive is detonated to collapse the liner and ejects it from one end of the shaped charge at a very high velocity in a pattern called a “jet”. The jet penetrates and perforates the casing, the cement and a quantity of the earth formation. In order to provide perforations which have efficient hydraulic communication with the formation, it is known in the art to design shaped charges in various ways to provide a jet which can penetrate a large quantity of formation, the quantity usually referred to as the “penetration depth” of the perforation. The jet from the metal liners also may leave a residue in the resulting perforation, thereby reducing the efficiency and productivity of the well.

Furthermore, once a shape charge gun has been fired, in addition to addressing the issues regarding the residual liner material left in the perforation, the components other than the liner must generally also be removed from the wellbore, which generally require additional costly and time consuming removal operations.

Therefore, perforation systems and methods of using them that incorporate liners and other components formed from materials that may be selectively removed from the wellbore are very desirable.

### SUMMARY

In an exemplary embodiment, a selectively corrodible powder compact is disclosed. The selectively corrodible powder compact includes a cellular nanomatrix comprising a nanomatrix material. The selectively corrodible powder compact also includes a plurality of dispersed particles comprising a particle core material having a density of about 7.5 g/cm³ or more, dispersed in the cellular nanomatrix. The selectively corrodible powder compact further includes a bond layer extending throughout the cellular nanomatrix between the dispersed particles.

### BRIEF DESCRIPTION OF THE DRAWINGS

Referring now to the drawings wherein like elements are numbered alike in the several Figures:

FIG. 1 is a partial cutaway view of an exemplary embodiment of a perforating system and method of using the same as disclosed herein;

FIG. 2 is a cross-sectional view of an exemplary embodiment of a shaped charge as disclosed herein;

FIG. 3 is a perspective view of an exemplary embodiment of a perforating system, including shaped charges and a shaped charge housing as disclosed herein;

FIG. 4 is a cross-sectional view of an exemplary embodiment of a perforating system, including shaped charges, a shaped charge housing and an outer housing as disclosed herein;

FIG. 5 is a cross-sectional view of an exemplary embodiment of a coated powder as disclosed herein; and

FIG. 6 is a cross-sectional view of a nanomatrix material as may be used to make a selectively corrodible perforating system as disclosed herein;

FIG. 7 is a schematic of illustration of an exemplary embodiment of the powder compact have a substantially elongated configuration of dispersed particles as disclosed herein;

FIG. 8 is a schematic of illustration of an exemplary embodiment of the powder compact have a substantially elongated configuration of the cellular nanomatrix and dispersed particles, wherein the cellular nanomatrix and dispersed particles are substantially continuous; and

FIG. 9 is a schematic of illustration of an exemplary embodiment of the powder compact have a substantially elongated configuration of the cellular nanomatrix and dispersed particles, wherein the cellular nanomatrix and dispersed particles are substantially discontinuous.

### DETAILED DESCRIPTION

Generally, a selectively and controllably corrodible perforating system and method of using the perforating system for perforating a wellbore, either cased or open (i.e., uncased) is disclosed, as well as powder compact material compositions that may be used to form the various components of the selectively corrodible perforating system, particularly powder compacts comprising a cellular nanomatrix having a plurality particles of a particle core material dispersed therein. The selectively corrodible materials described herein may be corroded, dissolved or otherwise removed from the wellbore as described herein in response to a predetermined wellbore condition, such as exposure of the materials to a predetermined wellbore fluid, such as an acid, a fracturing fluid, an injection fluid, or a completions fluid, as described herein.

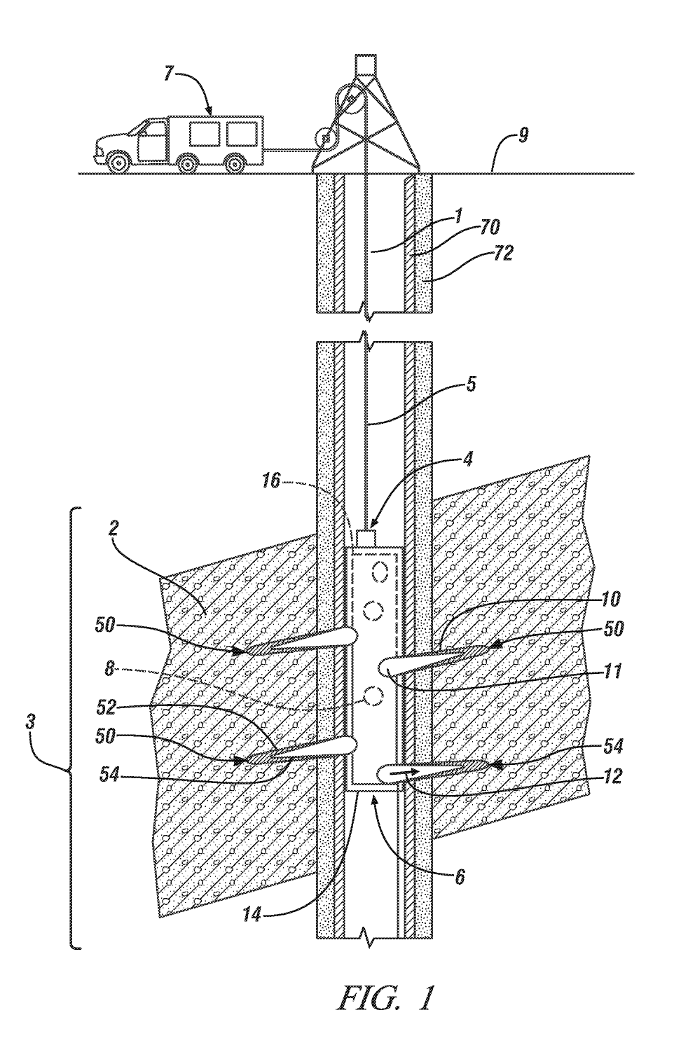

Referring to FIG. 1, after a well or wellbore 1 is drilled, a casing 70 is typically run in the wellbore 1 and cemented into the well in order to maintain well integrity. After the casing 70 has been cemented with cement 72 in the wellbore 1, one or more sections of the casing 70 that are adjacent to the formation zones 3 of interest (e.g., target well zone) may be perforated to allow fluid from the formation zone 3 to flow into the well for production to the surface or to allow injection fluids to be applied into the formation zones 3. To perforate a casing 70 section, a selectively corrodible perforating system 4 comprising a selectively corrodible perforating gun 6 string may be lowered into the wellbore 1 to the desired depth of the formation zone 3 of interest, and one or more perforation guns 6 are fired to create openings 11 in the casing 70 and to extend perforations 10 into the formation zone 3. Production fluids in the perforated formation zone 3 can then flow through the perforations 10 and the casing openings 11 into the wellbore 1, for example.

Referring again to FIG. 1, an exemplary embodiment of a selectively corrodible perforating system 4 comprises one or more selectively corrodible perforating guns 6 strung together. These strings of guns 6 can have any suitable length, including a thousand feet or more of perforating length. For purposes of illustration, the perforating system 4 depicted comprises a single selectively corrodible perforating gun 6 rather than multiple guns. The gun 6 is shown disposed within a wellbore 1 on a wireline 5. As an example, the perforating system 4 as shown also includes a service truck 7 on the surface 9, where in addition to providing a raising and lowering system for the perforating system 4, the wireline 5 also may provide communication and control system between the truck 7 and the surface generally and the perforating gun 6 in the wellbore 1. The wireline 5 may be threaded through various pulleys and supported above the wellbore 1.

Perforating guns 6 includes a gun strip or shaped charge housing 16 that is configured to house one or more shaped charges 8 and that is coaxially housed within a gun body or outer housing 14. Both shaped charge housing 16 outer housing 14 may have any suitable shape, including an annular shape, and may be formed from any suitable material, including conventional housing materials, and in an exemplary embodiment either or both may be formed from a selectively corrodible material as described herein.

In an exemplary embodiment, shaped charge housing 16 may be formed from a selectively corrodible shaped charge housing material 17 as described herein. In another exemplary embodiment, outer housing 14 may be formed from a selectively corrodible material 15. The selectively corrodible outer housing material 15 and shaped charge housing material 17 may be the same material or different materials as described herein.

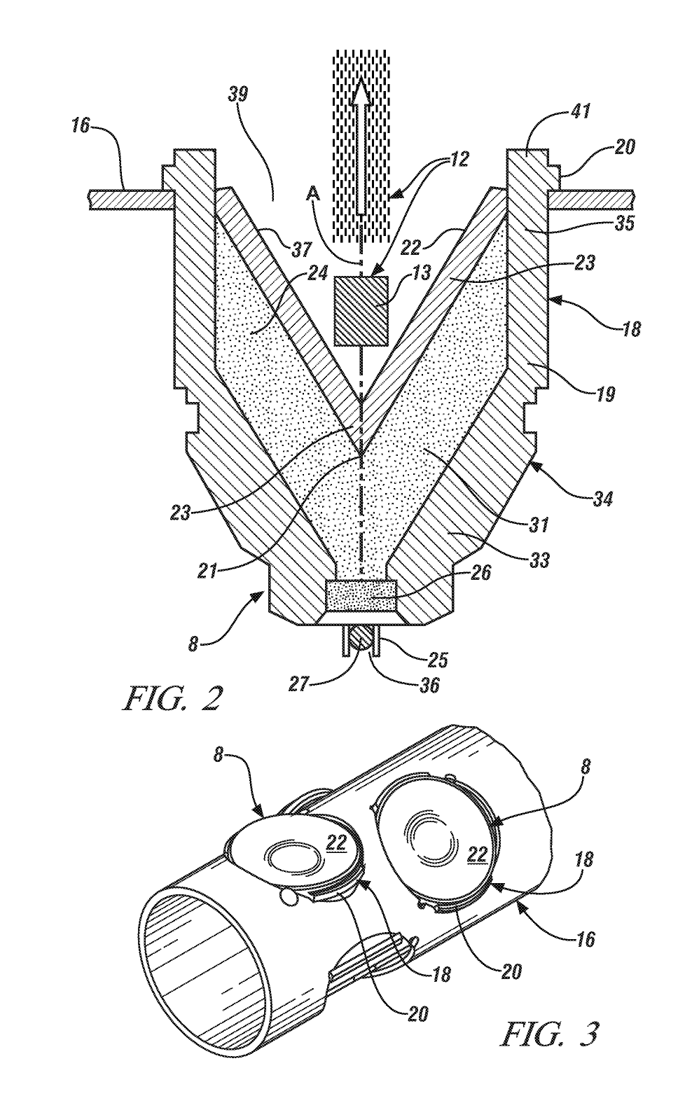

Shaped charges 8 are housed within the shaped charge housing 16 and aimed outwardly generally perpendicular to the axis of the wellbore 1. As illustrated in FIG. 2, in an exemplary embodiment a selectively corrodible shaped charge 8 includes a housing or charge case 18 formed from a selectively corrodible charge case material 19, a selectively corrodible shaped charge liner 22 formed from a selectively corrodible liner material 23 disposed within the charge case 18 generally axially along a longitudinal axis of the case, a quantity comprising a main charge 24 of high explosive material disposed within the charge case and deposited between the liner 22 and the charge case 18, and a booster charge 26 proximate the base of the high explosive 24 and configured for detonation of the high explosive.

Referring to FIGS. 2, a shaped charge 8 in accordance with embodiments of the present invention includes a charge case 18 that acts as a containment vessel designed to hold the detonation force of the detonating explosion long enough for a perforating jet 12 (FIGS. 1 and 2) to form. The case body 34 is a container-like structure having a bottom wall 33 section sloping upward with respect to the axis A of the charge case 18. The charge case 18 as shown is substantially symmetric about the axis A. In the embodiment shown, the charge case 18 transitions into the upper wall 35 portion where the slope of the wall steepens, including the orientation shown where the upper wall 35 is substantially parallel to the axis A. The upper portion 35 also has a profile oblique to the axis A. Extending downward from the bottom portion 33 is a cord slot 36 having a pair of tabs 25. The tabs 25 are configured to receive a detonating cord 27 therebetween and are generally parallel with the axis A of the charge case 18. A crown wall 41 portion defines the uppermost portion of the case body 34 extending from the upper terminal end of the upper portion 35. The uppermost portion of the crown portion 41 defines the opening 39 of the charge case 18 and lies in a plane that is substantially perpendicular to the axis A. A boss element 20 is provided on the outer surface of the crown portion 41. The boss 20 is an elongated member whose elongate section partially circumscribes a portion of the outer peripheral radius of the crown portion 41, and thus partially circumscribes the outer circumference of the charge case 18. In the embodiment shown, the boss 20 cross-section is substantially rectangular and extends radially outwardly from the outer surface of the charge case 18. While the charge case 8 shown is generally cylindrical, charge case 18 may have any shape suitable for housing the liner 22 and main charge 24 as described herein.

The shaped charges 8 may be positioned within the shaped charge housing 16 in any orientation or configuration, including a high density configuration of at least 10-12 shaped charges 8 per linear foot of perforating gun. In some instances however high density shots may include guns having as few as 6 shaped charge 8 shots per linear foot. Referring to FIG. 3, the shaped charge housing 16 provides an example of a high density configuration. The charges carried in a perforating gun 6 may be phased to fire in multiple directions around the circumference of the wellbore 1. Alternatively, the charges may be aligned in a straight line or in any predetermined firing pattern. When fired, the charges create perforating jets 12 that form openings 11 or perforations or holes in the surrounding casing 70 as well as extend perforations 10 into the surrounding formation zone 3.

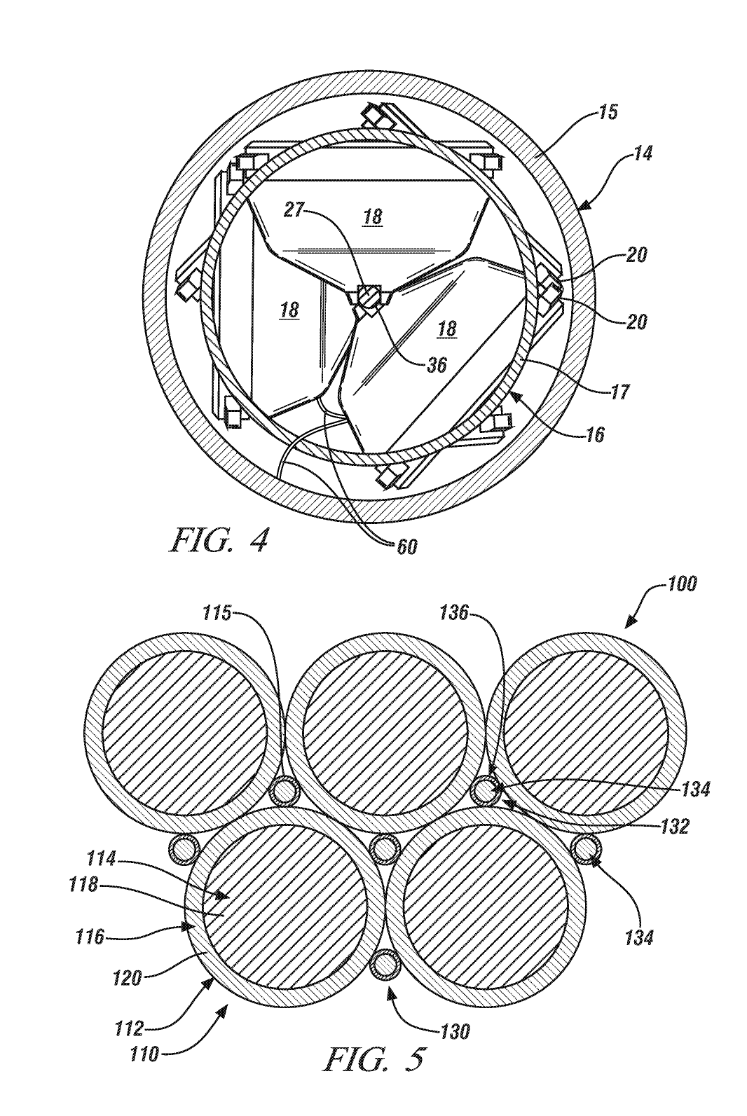

FIG. 4 provides a view looking along the axis of the shaped charge housing 16 having multiple charge casings 18 disposed therein. In this view, a detonating cord 27 is shown coupled within the tabs 25 and cord slot 36 of the respective charge casings 18. The respective cord slots 36 of the charge cases 18 are aligned for receiving the detonation cord 27 therethrough. The shaped charge housing 16 is disposed within outer housing 14. As indicated the portion of outer housing 14 proximate shaped charges 8 may have the wall thickness reduced in a window, such as a generally circular window, either from the outer surface or inner surface, or both, to reduce the energy needed for the liner material to pierce through the housing and increase the energy available to penetrate the formation.

The liner 22 may have any suitable shape. In the exemplary embodiment of FIG. 2, the liner 22 is generally frustoconical in shape and is distributed substantially symmetrically about the axis A. Liner 22 generally may be described as having a sidewall 37 that defines an apex 21 and a liner opening 39. Other liner 22 shapes are also possible, including a multi-sectional liner having two or more frustoconical sections with different taper angles, such as one that opens at a first taper angle and a second taper angle that opens more rapidly that the first taper angle, a tulip-shaped liner, which as its name suggest mimics the shape of a tulip, a fully or partially (e.g., combination of a cylindrical or frustoconical sidewall and hemispherical apex) hemispherical liner, a generally frusto-conical liner having a rounded or curved apex, a linear liner having a V-shaped cross section with straight wall sides or a trumpet-shaped liner having generally conically shaped with curved sidewall that curve outwardly as they extend from the apex of the liner to the liner opening. Liner 22 may be formed as described herein to provide a porous powder compact having less than full theoretical density, so that the liner 22 substantially disintegrates into a perforating jet of particles upon detonation of the main charge 24 and avoids the formation of a “carrot” or “slug” of solid material. Liner 22 may also be formed as a solid material having substantially full theoretical density and the jet 12 formed therefrom may include a carrot 13 or slug. In either case, liner 22 is formed from selectively corrodible liner material 23 and is configured for removal of residual liner material 23 from the perforations 10 as described herein.

The main charge 24 is contained inside the charge case 18 and is arranged between the inner surface 31 of the charge case and the liner 22. A booster charge 26 or primer column or other ballistic transfer element is configured for explosively coupling the main explosive charge 24 and a detonating cord 27, which is attached to an end of the shaped charge, by providing a detonating link between them. Any suitable explosives may be used for the high explosive 24, booster charge 26 and detonating cord 27. Examples of explosives that may be used in the various explosive components (e.g., charges, detonating cord, and boosters) include RDX (cyclotrimethylenetrinitramine or hexahydro-1,3,5-trinitro-1,3,5-triazine), HMX (cyclotetramethylenetetranitramine or 1,3,5,7-tetranitro-1,3,5,7-tetraazacyclooctane), TATB (triaminotrinitrobenzene), HNS (hexanitrostilbene), and others.

In an exemplary embodiment, in order to detonate the main charge 24 of shaped charge 8, a detonation wave traveling through the detonating cord 27 initiates the booster charge 26 when the detonation wave passes by, which in turn initiates detonation of the main explosive charge 24 to create a detonation wave that sweeps through the shaped charge. The liner 22 collapses under the detonation force of the main explosive charge. The shaped charges 8 are typically explosively coupled to or connected to a detonating cord 27 which is affixed to the shaped charge 8 by a case slot 25 and located proximate the booster charge 26. Detonating the detonating cord 27 creates a compressive pressure wave along its length that in turn detonates the booster charge 26 that in turn detonates the high explosive 24. When the high explosive 24 is detonated, the force of the detonation collapses the liner 22, generally pushing the apex 21 through the liner opening 39 and ejects it from one end of the shaped charge 8 at very high velocity in a pattern of the liner material that is called a perforating jet 12. The perforating jet 12 may have any suitable shape, but generally includes a high velocity pattern of fragments of the liner material on a leading edge and, particularly in the case of solid liner material 23, may also include a trailing carrot or slug comprising a substantially solid mass of the liner material. The perforating jet 12 is configured to shoot out of the open end 39 of the charge case 18 and perforate the outer housing 14, casing 70 and any cement 72 lining the wellbore 1 and create a perforation 10 in the formation 2, usually having the shape of a substantially conical or bullet-shaped funnel that tapers inwardly away from the wellbore 1 and extends into the surrounding earth formation 2. Around the surface region adjacent to the perforation 10 or tunnel, a layer of charge liner residue 50. The charge liner residue 50 includes “wall” residue 52 deposited on the wall of the perforation 10 and “tip” residue 54 deposited at the tip of the perforation. The selectively corrodible liner material 23 disclosed herein enables selective and rapid removal of the charge liner residue 50, including the wall residue 52 and tip residue 54 from the perforation in response to a predetermined wellbore condition, such as exposure of the charge liner residue 50 to a predetermined wellbore fluid of the types described herein. The removal of the charge liner residue, particularly the tip residue, is very advantageous, because it enables the unhindered flow of wellbore fluids into and out of the perforation through the tip portion, thereby increasing the productivity of the individual perforations and hence the overall productivity of the wellbore 1.

In accordance with embodiments of the present invention, the shaped charge 8 includes a liner 22 fabricated from a material that is selectively corrodible in the presence of a suitable predetermined wellbore fluid (e.g., an acid, an injection fluid, a fracturing fluid, or a completions fluid). As a result, any liner residue remaining in the perforation tunnel post-detonation (specifically, in the tip region of the tunnel) may be dissolved into the dissolving fluid and will no longer be detrimental to injection or other operations. It is significant that the material used in the charge liner be targeted to correspond with a dissolving fluid in which the liner material is soluble in presence of Perforating system 4 may also include a galvanic member 60, such as a metallic or conductive member, that is selected to promote galvanic coupling and dissolution or corrosion of the selectively corrodible members, particularly one or more of charge cases 18, shape charge housing 16 or outer housing 14.

Once the shaped charges 8 have been fired, it is also desirable to remove remaining portions of the perforating system 4 from the wellbore, particularly the shaped charge case 18, shaped charge housing 16 and outer housing 14. In an exemplary embodiment, where charge case 18 is formed from selectively corrodible charge case material 19, and one or both of shaped charge housing 16 and outer housing 14 is formed from selectively corrodible shaped charge housing material 17 and selectively corrodible outer housing material 15, respectively, the remaining portions of perforating system 4 that are formed from a selectively corrodible material may be removed from the wellbore by exposure to a predetermined wellbore fluid, as described herein. The remainder of the perforating system 4 may be selectively corroded, dissolved or otherwise removed from the wellbore at the same time as the charge liner residue 50 by exposure to the same predetermined wellbore fluid. Alternately, the remainder of perforating system 4 may be removed from the wellbore at a different time by exposure to a different predetermined wellbore fluid.

As described, the selectively corrodible materials described herein may be corroded, dissolved or otherwise removed from the wellbore as described herein in response to a predetermined wellbore condition, such as exposure of the materials to a predetermined wellbore fluid, such as an acid, a fracturing fluid, an injection fluid, or a completions fluid, as described herein. Acids that may be used to dissolve any charge liner residue in acidizing operations include, but are not limited to: hydrochloric acid, hydrofluoric acid, acetic acid, and formic acid. Fracturing fluids that may be used to dissolve any charge liner residue in fracturing operations include, but are not limited to: acids, such as hydrochloric acid and hydrofluoric acid. Injection fluids that may be pumped into the formation interval to dissolve any charge liner residue include, but are not limited to: water and seawater. Completion fluids that may be circulated proximate the formation interval to dissolve any charge liner residue include, but are not limited to, brines, such as chlorides, bromides and formates.

A method for perforating in a well include: (1) disposing a perforating gun in the well, wherein the perforating gun comprises a shaped charge having a charge case, an explosive disposed inside the charge case, and a liner for retaining the explosive in the charge case, wherein the liner includes a material that is soluble with an acid, an injection fluid, a fracturing fluid, or a completions fluid; (2) detonating the shaped charge to form a perforation tunnel in a formation zone and leaving charge liner residue within the perforating tunnel (on the well and tip); (3) performing one of the following: (i) pumping an acid downhole, (ii) pumping a fracturing fluid downhole, (iii) pumping an injection fluid downhole, or (iv) circulating a completion or wellbore fluid downhole to contact the charge liner residue in the perforation tunnel; and (4) allowing the material comprising the charge liner residue to dissolve with the acid, an injection fluid, a fracturing fluid, or a completions fluid. After such operation, a treatment fluid may be injected into the formation and/or the formation may be produced.

In an exemplary embodiment, the selectively corrodible perforating system 4 components described herein may be formed from selectively corrodible nanomatrix materials. These include: the shaped charge 8 comprising shaped charge housing 16 and shaped charge housing material 19 and liner 22 and selectively corrodible liner material 23, shaped charge housing 16 and selectively corrodible shaped charge housing material 17, and outer housing 14 and selectively corrodible outer housing material 15. The Nanomatrix materials and methods of making these materials are described generally, for example, in U.S. patent application Ser. No. 12/633,682 filed on Dec. 8, 2009 and U.S. patent application Ser. No. 13/194,361 filed on Jul. 29, 2011, which are hereby incorporated herein by reference in their entirety. These lightweight, high-strength and selectably and controllably degradable materials may range from fully-dense, sintered powder compacts to precursor or green state (less than fully dense) compacts that may be sintered or unsintered. They are formed from coated powder materials that include various lightweight particle cores and core materials having various single layer and multilayer nanoscale coatings. These powder compacts are made from coated metallic powders that include various electrochemically-active (e.g., having relatively higher standard oxidation potentials) lightweight, high-strength particle cores and core materials, such as electrochemically active metals, that are dispersed within a cellular nanomatrix formed from the consolidation of the various nanoscale metallic coating layers of metallic coating materials, and are particularly useful in wellbore applications. The powder compacts may be made by any suitable powder compaction method, including cold isostatic pressing (CIP), hot isostatic pressing (HIP), dynamic forging and extrusion, and combinations thereof These powder compacts provide a unique and advantageous combination of mechanical strength properties, such as compression and shear strength, low density and selectable and controllable corrosion properties, particularly rapid and controlled dissolution in various wellbore fluids. The fluids may include any number of ionic fluids or highly polar fluids, such as those that contain various chlorides. Examples include fluids comprising potassium chloride (KCl), hydrochloric acid (HCl), calcium chloride (CaCl₂), calcium bromide (CaBr₂) or zinc bromide (ZnBr₂). The disclosure of the ‘682 and ‘361 applications regarding the nature of the coated powders and methods of making and compacting the coated powders are generally applicable to provide the selectively corrodible nanomatrix materials disclosed herein, and for brevity, are not repeated herein.

As illustrated in FIGS. 1 and 2, the selectively corrodible materials disclosed herein may be formed from a powder 100 comprising powder particles 112, including a particle core 114 and core material 118 and metallic coating layer 116 and coating material 120, may be selected that is configured for compaction and sintering to provide a powder metal compact 200 that is selectably and controllably removable from a wellbore in response to a change in a wellbore property, including being selectably and controllably dissolvable in a predetermined wellbore fluid, including various predetermined wellbore fluids as disclosed herein. The powder metal compact 200 includes a cellular nanomatrix 216 comprising a nanomatrix material 220 and a plurality of dispersed particles 214 comprising a particle core material 218 as described herein dispersed in the cellular nanomatrix 216.

As described herein, the shaped charge 8 comprising shaped charge housing 16 and shaped charge housing material 19 and liner 22 and selectively corrodible liner material 23, shaped charge housing 16 and selectively corrodible shaped charge housing material 17, and outer housing 14 and selectively corrodible outer housing material 15 may be formed from the same materials or different materials. In an exemplary embodiment, it is desirable to form the shaped charge 8, including the shaped charge housing 16 or liner 22, or both of them, from a nanomatrix material that provides a mechanical shock impedance or mechanical shock response that enables containment of the explosion by the shaped charge housing 16 and formation of jet 12 from liner 22 that is configured to penetrate various earth formations, such as, for example, materials having a high density and ductility. In another exemplary embodiment, it is desirable to form the shaped charge housing 16 or outer housing 14, or both of them, from a lightweight, high-strength material sufficient to house the shaped charges 8.

Dispersed particles 214 may comprise any of the materials described herein for particle cores 114, even though the chemical composition of dispersed particles 214 may be different due to diffusion effects as described herein. In an exemplary embodiment, the shaped charge 8, including the shaped charge housing 16 and liner 22, may include dispersed particles 214 that are formed from particle cores 114 with particle core material having a density of about 7.5 g/cm³ or more, and more particularly a density of about 8.5 g/cm³ or more, and even more particularly a density of about 10 g/cm³ or more. More particularly, particle cores 114 may include a particle core material 118 that comprises a metal, ceramic, cermet, glass or carbon, or a composite thereof, or a combination of any of the foregoing materials. Even more particularly, particle cores 114 may include a particle core material 118 that comprises Fe, Ni, Cu, W, Mo, Ta, U or Co, or a carbide, oxide or nitride comprising at least one of the foregoing metals, or an alloy comprising at least one of the aforementioned materials, or a composite comprising at least one of the aforementioned materials, or a combination of any of the foregoing. If uranium is used, it may include depleted uranium, since it is commercially more readily available. The dispersed particles 214 may be formed from a single particle core material or multiple particle core materials. In one embodiment, dispersed particles 214 are formed from particle cores 114 that comprise up to about 50 volume percent of an Mg—Al alloy, such as an alloy of Mg-10 wt. % Al, and about 50 volume percent or more of a W—Al alloy, such as an alloy of W-10 wt. % Al. In another embodiment, dispersed particles 214 are formed from particle cores 114 that comprise up to about 50 volume percent of an Mg—Al alloy, such as an alloy of Mg-10 wt. % Al, and about 50 volume percent or more of a Zn—Al alloy, such as an alloy of Zn-10 wt. % Al. In yet another embodiment, dispersed particles 214 are formed from particle cores 114 that comprise up to about 50 volume percent of an Mg—Ni alloy, such as an alloy of Mg-5 wt. % Ni, and about 50 volume percent or more of a W—Ni alloy, such as an alloy of W-5 wt. % Ni. In these embodiments that are formed from a mixture of different powders 110 and powder particles 112 having different particle core materials 118, at least a portion (e.g., 50 volume percent or more) of the particle cores 114 have a density greater than 7.5 g/cm³. In other embodiments, dispersed particles 214 may be formed from a powder 100 having powder particles 112 with particle cores 114 formed from particle core materials 118 that include alloys, wherein the alloy has a density greater than about 7.5 g/cm³, such as may be formed from binary, ternary, etc. alloys having at least one alloy constituent with a density greater than about 7.5 g/cm³. The particle cores 114 and particle core material of the liner 22 are preferably formed from ductile materials. In an exemplary embodiment, ductile materials include materials that exhibit 5% or more of true strain or elongation at failure or breaking.

In an exemplary embodiment, the shaped charge housing 16 and/or outer housing 14 may include dispersed particles 214 that are formed from particle cores 114 with any suitable particle core material, including, in one embodiment, the same particle core materials used to form the components of shaped charge 8. In another exemplary embodiment, they may be formed from dispersed particles 214 that are formed from particle cores 114 having a particle core material 118 comprising Mg, Al, Zn or Mn, or alloys thereof, or a combination thereof.

Dispersed particles 214 and particle core material 218 may also include a rare earth element, or a combination of rare earth elements. As used herein, rare earth elements include Sc, Y, La, Ce, Pr, Nd or Er, or a combination of rare earth elements. Where present, a rare earth element or combination of rare earth elements may be present, by weight, in an amount of about 5 percent or less.

Powder compact 200 includes a cellular nanomatrix 216 of a nanomatrix material 220 having a plurality of dispersed particles 214 dispersed throughout the cellular nanomatrix 216. The dispersed particles 214 may be equiaxed in a substantially continuous cellular nanomatrix 216, or may be substantially elongated as described herein and illustrated in FIG. 3. In the case where the dispersed particles 214 are substantially elongated, the dispersed particles 214 and the cellular nanomatrix 216 may be continuous or discontinuous, as illustrated in FIGS. 4 and 5, respectively. The substantially-continuous cellular nanomatrix 216 and nanomatrix material 220 formed of sintered metallic coating layers 116 is formed by the compaction and sintering of the plurality of metallic coating layers 116 of the plurality of powder particles 112, such as by CIP, HIP or dynamic forging. The chemical composition of nanomatrix material 220 may be different than that of coating material 120 due to diffusion effects associated with the sintering. Powder metal compact 200 also includes a plurality of dispersed particles 214 that comprise particle core material 218. Dispersed particle 214 and core material 218 correspond to and are formed from the plurality of particle cores 114 and core material 118 of the plurality of powder particles 112 as the metallic coating layers 116 are sintered together to form nanomatrix 216. The chemical composition of core material 218 may also be different than that of core material 118 due to diffusion effects associated with sintering.

As used herein, the use of the term cellular nanomatrix 216 does not connote the major constituent of the powder compact, but rather refers to the minority constituent or constituents, whether by weight or by volume. This is distinguished from most matrix composite materials where the matrix comprises the majority constituent by weight or volume. The use of the term substantially-continuous, cellular nanomatrix is intended to describe the extensive, regular, continuous and interconnected nature of the distribution of nanomatrix material 220 within powder compact 200. As used herein, “substantially-continuous” describes the extension of the nanomatrix material throughout powder compact 200 such that it extends between and envelopes substantially all of the dispersed particles 214. Substantially-continuous is used to indicate that complete continuity and regular order of the nanomatrix around each dispersed particle 214 is not required. For example, defects in the coating layer 116 over particle core 114 on some powder particles 112 may cause bridging of the particle cores 114 during sintering of the powder compact 200, thereby causing localized discontinuities to result within the cellular nanomatrix 216, even though in the other portions of the powder compact the nanomatrix is substantially continuous and exhibits the structure described herein. In contrast, in the case of substantially elongated dispersed particles 214, such as those formed by extrusion, “substantially discontinuous” is used to indicate that incomplete continuity and disruption (e.g., cracking or separation) of the nanomatrix around each dispersed particle 214, such as may occur in a predetermined extrusion direction 622, or a direction transverse to this direction. As used herein, “cellular” is used to indicate that the nanomatrix defines a network of generally repeating, interconnected, compartments or cells of nanomatrix material 220 that encompass and also interconnect the dispersed particles 214. As used herein, “nanomatrix” is used to describe the size or scale of the matrix, particularly the thickness of the matrix between adjacent dispersed particles 214. The metallic coating layers that are sintered together to form the nanomatrix are themselves nanoscale thickness coating layers. Since the nanomatrix at most locations, other than the intersection of more than two dispersed particles 214, generally comprises the interdiffusion and bonding of two coating layers 16 from adjacent powder particles 112 having nanoscale thicknesses, the matrix formed also has a nanoscale thickness (e.g., approximately two times the coating layer thickness as described herein) and is thus described as a nanomatrix. Further, the use of the term dispersed particles 214 does not connote the minor constituent of powder compact 200, but rather refers to the majority constituent or constituents, whether by weight or by volume. The use of the term dispersed particle is intended to convey the discontinuous and discrete distribution of particle core material 218 within powder compact 200.

Particle cores 114 and dispersed particles 214 of powder compact 200 may have any suitable particle size. In an exemplary embodiment, the particle cores 114 may have a unimodal distribution and an average particle diameter or size of about 5 μm to about 300 μm, more particularly about 80 μm to about 120 μm, and even more particularly about 100 μm. In another exemplary embodiment, which may include a multi-modal distribution of particle sizes, the particle cores 114 may have average particle diameters or size of about 50 nm to about 500 μm, more particularly about 500 nm to about 300 μm, and even more particularly about 5 μm to about 300 μm. In an exemplary embodiment, the particle cores 114 or the dispersed particles may have an average particle size of about 50 nm to about 500 μm.

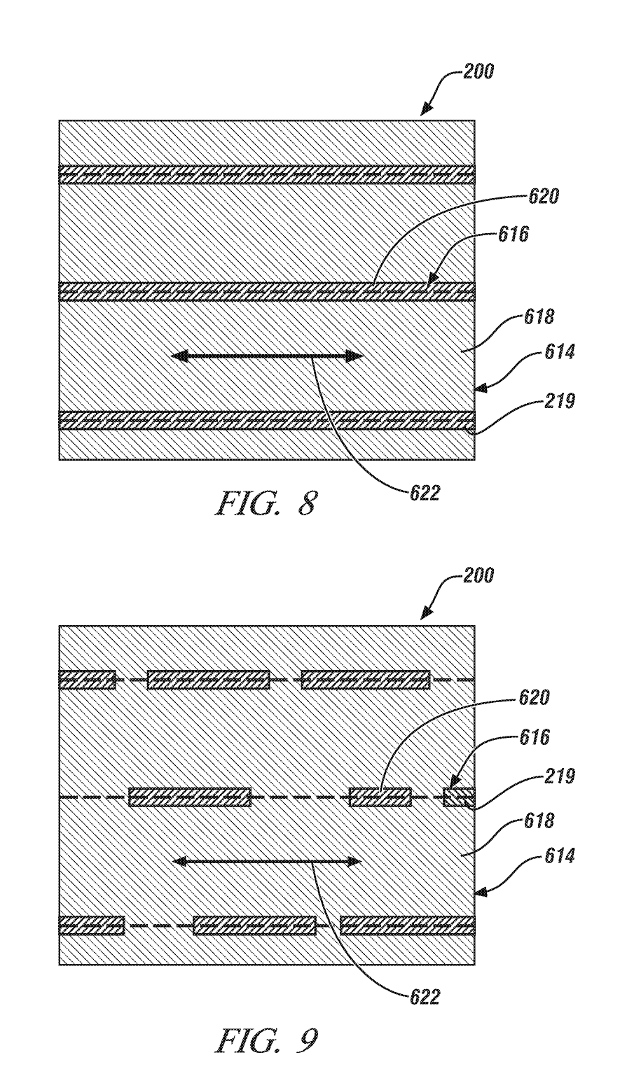

Dispersed particles 214 may have any suitable shape depending on the shape selected for particle cores 114 and powder particles 112, as well as the method used to sinter and compact powder 100. In an exemplary embodiment, powder particles 112 may be spheroidal or substantially spheroidal and dispersed particles 214 may include an equiaxed particle configuration as described herein. In another exemplary embodiment as shown in FIGS. 7-9, dispersed particles may have a non-spherical shape. In yet another embodiment, the dispersed particles may be substantially elongated in a predetermined extrusion direction 622, such as may occur when using extrusion to form powder compact 200. As illustrated in FIG. 3-5, for example, a substantially elongated cellular nanomatrix 616 comprising a network of interconnected elongated cells of nanomatrix material 620 having a plurality of substantially elongated dispersed particle cores 614 of core material 618 disposed within the cells. Depending on the amount of deformation imparted to form elongated particles, the elongated coating layers and the nanomatrix 616 may be substantially continuous in the predetermined direction 622 as shown in FIG. 4, or substantially discontinuous as shown in FIG. 5.

The nature of the dispersion of dispersed particles 214 may be affected by the selection of the powder 100 or powders 100 used to make particle compact 200. In one exemplary embodiment, a powder 100 having a unimodal distribution of powder particle 112 sizes may be selected to form powder compact 200 and will produce a substantially homogeneous unimodal dispersion of particle sizes of dispersed particles 214 within cellular nanomatrix 216. In another exemplary embodiment, a plurality of powders 100 having a plurality of powder particles with particle cores 114 that have the same core materials 118 and different core sizes and the same coating material 120 may be selected and uniformly mixed as described herein to provide a powder 100 having a homogenous, multimodal distribution of powder particle 112 sizes, and may be used to form powder compact 200 having a homogeneous, multimodal dispersion of particle sizes of dispersed particles 214 within cellular nanomatrix 216. Similarly, in yet another exemplary embodiment, a plurality of powders 10 having a plurality of particle cores 114 that may have the same core materials 118 and different core sizes and the same coating material 120 may be selected and distributed in a non-uniform manner to provide a non-homogenous, multimodal distribution of powder particle sizes, and may be used to form powder compact 200 having a non-homogeneous, multimodal dispersion of particle sizes of dispersed particles 214 within cellular nanomatrix 216. The selection of the distribution of particle core size may be used to determine, for example, the particle size and interparticle spacing of the dispersed particles 214 within the cellular nanomatrix 216 of powder compacts 200 made from powder 100.

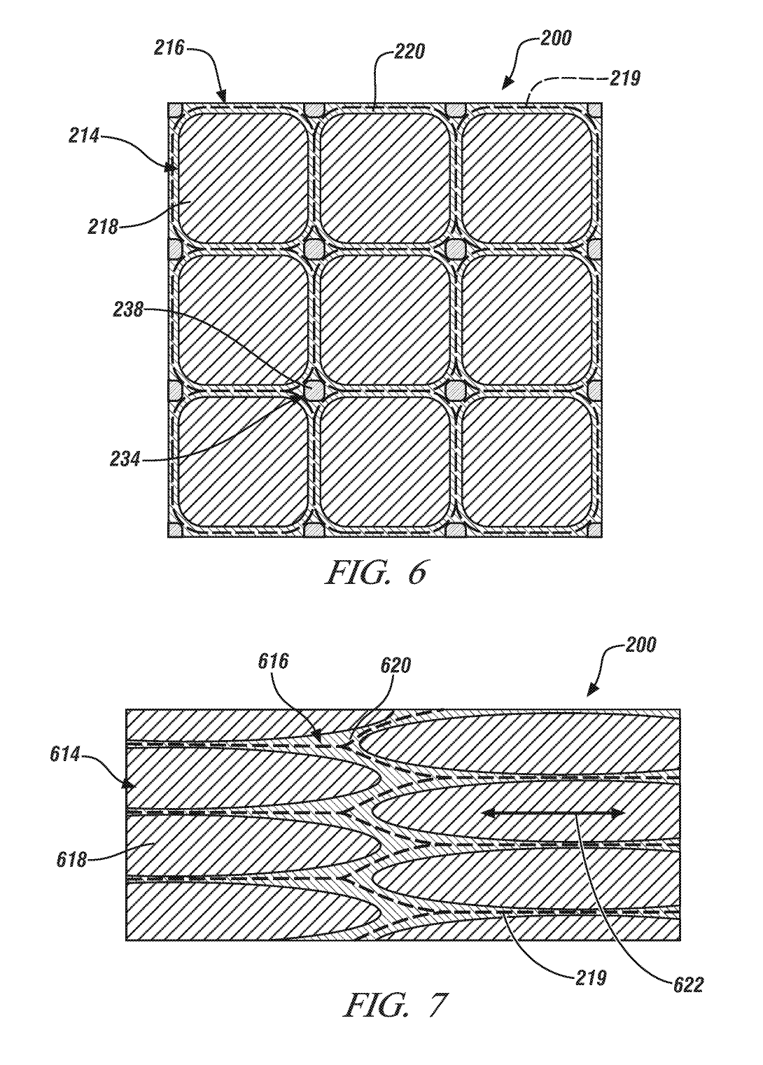

As illustrated generally in FIGS. 5 and 6, powder metal compact 200 may also be formed using coated metallic powder 100 and an additional or second powder 130, as described herein. The use of an additional powder 130 provides a powder compact 200 that also includes a plurality of dispersed second particles 234, as described herein, that are dispersed within the nanomatrix 216 and are also dispersed with respect to the dispersed particles 214. Dispersed second particles 234 may be formed from coated or uncoated second powder particles 132, as described herein. In an exemplary embodiment, coated second powder particles 132 may be coated with a coating layer 136 that is the same as coating layer 116 of powder particles 112, such that coating layers 136 also contribute to the nanomatrix 216. In another exemplary embodiment, the second powder particles 234 may be uncoated such that dispersed second particles 234 are embedded within nanomatrix 216. As disclosed herein, powder 100 and additional powder 130 may be mixed to form a homogeneous dispersion of dispersed particles 214 and dispersed second particles 234 or to form a non-homogeneous dispersion of these particles. The dispersed second particles 234 may be formed from any suitable additional powder 130 that is different from powder 100, either due to a compositional difference in the particle core 134, or coating layer 136, or both of them, and may include any of the materials disclosed herein for use as second powder 130 that are different from the powder 100 that is selected to form powder compact 200. In an exemplary embodiment, dispersed second particles 234 may include Ni, Fe, Cu, Co, W, Al, Zn, Mn or Si, or an oxide, nitride, carbide, intermetallic compound or cermet comprising at least one of the foregoing, or a combination thereof.

Nanomatrix 216 is formed by sintering metallic coating layers 116 of adjacent particles to one another by interdiffusion and creation of bond layer 219 as described herein. Metallic coating layers 116 may be single layer or multilayer structures, and they may be selected to promote or inhibit diffusion, or both, within the layer or between the layers of metallic coating layer 116, or between the metallic coating layer 116 and particle core 114, or between the metallic coating layer 116 and the metallic coating layer 116 of an adjacent powder particle, the extent of interdiffusion of metallic coating layers 116 during sintering may be limited or extensive depending on the coating thicknesses, coating material or materials selected, the sintering conditions and other factors. Given the potential complexity of the interdiffusion and interaction of the constituents, description of the resulting chemical composition of nanomatrix 216 and nanomatrix material 220 may be simply understood to be a combination of the constituents of coating layers 16 that may also include one or more constituents of dispersed particles 214, depending on the extent of interdiffusion, if any, that occurs between the dispersed particles 214 and the nanomatrix 216. Similarly, the chemical composition of dispersed particles 214 and particle core material 218 may be simply understood to be a combination of the constituents of particle core 114 that may also include one or more constituents of nanomatrix 216 and nanomatrix material 220, depending on the extent of interdiffusion, if any, that occurs between the dispersed particles 214 and the nanomatrix 216.

In an exemplary embodiment, the nanomatrix material 220 has a chemical composition and the particle core material 218 has a chemical composition that is different from that of nanomatrix material 220, and the differences in the chemical compositions may be configured to provide a selectable and controllable dissolution rate, including a selectable transition from a very low dissolution rate to a very rapid dissolution rate, in response to a controlled change in a property or condition of the wellbore proximate the compact 200, including a property change in a wellbore fluid that is in contact with the powder compact 200, as described herein. Nanomatrix 216 may be formed from powder particles 112 having single layer and multilayer coating layers 116. This design flexibility provides a large number of material combinations, particularly in the case of multilayer coating layers 116, that can be utilized to tailor the cellular nanomatrix 216 and composition of nanomatrix material 220 by controlling the interaction of the coating layer constituents, both within a given layer, as well as between a coating layer 116 and the particle core 114 with which it is associated or a coating layer 116 of an adjacent powder particle 112. Several exemplary embodiments that demonstrate this flexibility are provided below.

As illustrated in FIGS. 5 and 6, in an exemplary embodiment, powder compact 200 is formed from powder particles 112 where the coating layer 116 comprises a single layer, and the resulting nanomatrix 216 between adjacent ones of the plurality of dispersed particles 214 comprises the single metallic coating layer 116 of one powder particle 112, a bond layer 219 and the single coating layer 116 of another one of the adjacent powder particles 112. The thickness of bond layer 219 is determined by the extent of the interdiffusion between the single metallic coating layers 16, and may encompass the entire thickness of nanomatrix 216 or only a portion thereof. In other words, the compact is formed from a sintered powder 100 comprising a plurality of powder particles 112, each powder particle 112 having a particle core that upon sintering comprises a dispersed particle 114 and a single metallic coating layer 116 disposed thereon, and wherein the cellular nanomatrix 216 between adjacent ones of the plurality of dispersed particles 214 comprises the single metallic coating layer 116 of one powder particle 16, the bond layer 219 and the single metallic coating layer 116 of another of the adjacent powder particles 112. In another embodiment, the powder compact 200 is formed from a sintered powder 100 comprising a plurality of powder particles 112, each powder particle 112 having a particle core 114 that upon sintering comprises a dispersed particle 214 and a plurality of metallic coating layers 116 disposed thereon, and wherein the cellular nanomatrix 216 between adjacent ones of the plurality of dispersed particles 214 comprises the plurality of metallic coating layers 116 of one powder particle 112, the bond layer 219 and the plurality of metallic coating layers 116 of another of the powder particles 112, and wherein adjacent ones of the plurality of metallic coating layers 116 have different chemical compositions.

The cellular nanomatrix 216 may have any suitable nanoscale thickness. In an exemplary embodiment, the cellular nanomatrix 216 has an average thickness of about 50 nm to about 5000 nm.

In one exemplary embodiment, nanomatrix 216 may include Al, Zn, Mn, Mg, Mo, W, Cu, Fe, Si, Ca, Co, Ta, Re or Ni, or an oxide, carbide or nitride thereof, or a combination of any of the aforementioned materials, including combinations where the nanomatrix material 220 of cellular nanomatrix 216, including bond layer 219, has a chemical composition and the core material 218 of dispersed particles 214 has a chemical composition that is different than the chemical composition of nanomatrix material 220. The difference in the chemical composition of the nanomatrix material 220 and the core material 218 may be used to provide selectable and controllable dissolution in response to a change in a property of a wellbore, including a wellbore fluid, as described herein.

Powder compact 200 may have any desired shape or size, including that of a cylindrical billet, bar, sheet or other form that may be machined, formed or otherwise used to form useful articles of manufacture, including various wellbore tools and components. The pressing used to form precursor powder compact 100 and sintering and pressing processes used to form powder compact 200 and deform the powder particles 112, including particle cores 114 and coating layers 116, to provide the full density and desired macroscopic shape and size of powder compact 200 as well as its microstructure. The morphology (e.g. equiaxed or substantially elongated) of the dispersed particles 214 and nanomatrix 216 of particle layers results from sintering and deformation of the powder particles 112 as they are compacted and interdiffuse and deform to fill the interparticle spaces 115 (FIG. 1). The sintering temperatures and pressures may be selected to ensure that the density of powder compact 200 achieves substantially full theoretical density.

The powder compact 200 may be formed by any suitable forming method, including uniaxial pressing, isostatic pressing, roll forming, forging, or extrusion at a forming temperature. The forming temperature may be any suitable forming temperature. In one embodiment, the forming temperature may comprise an ambient temperature, and the powder compact 200 may have a density that is less than the full theoretical density of the particles 112 that form compact 200, and may include porosity. In another embodiment, the forming temperature the forming temperature may comprise a temperature that is about is about 20° C. to about 300° C. below a melting temperature of the powder particles, and the powder compact 200 may have a density that is substantially equal to the full theoretical density of the particles 112 that form the compact, and may include substantially no porosity.

The terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Furthermore, unless otherwise limited all ranges disclosed herein are inclusive and combinable (e.g., ranges of “up to about 25 weight percent (wt. %), more particularly about 5 wt. % to about 20 wt. % and even more particularly about 10 wt. % to about 15 wt. %” are inclusive of the endpoints and all intermediate values of the ranges, e.g., “about 5 wt. % to about 25 wt. %, about 5 wt. % to about 15 wt. %”, etc.). The use of “about” in conjunction with a listing of constituents of an alloy composition is applied to all of the listed constituents, and in conjunction with a range to both endpoints of the range. Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

It is to be understood that the use of “comprising” in conjunction with the alloy compositions described herein specifically discloses and includes the embodiments wherein the alloy compositions “consist essentially of the named components (i.e., contain the named components and no other components that significantly adversely affect the basic and novel features disclosed), and embodiments wherein the alloy compositions “consist of the named components (i.e., contain only the named components except for contaminants which are naturally and inevitably present in each of the named components).

While one or more embodiments have been shown and described, modifications and substitutions may be made thereto without departing from the spirit and scope of the invention. Accordingly, it is to be understood that the present invention has been described by way of illustrations and not limitation.

1. A selectively corrodible powder compact, comprising:
a cellular nanomatrix comprising a nanomatrix material;
a plurality of dispersed particles comprising a particle core material having a density of about 7.5 g/cm³ or more dispersed in the cellular nanomatrix; and
a bond layer extending throughout the cellular nanomatrix between the dispersed particles.

2. The powder compact of claim 1, wherein the particle core material comprises a metal, ceramic, cermet, glass or carbon, or a composite thereof, or a combination of any of the foregoing materials.

3. The powder compact of claim 1, wherein the particle core material comprises Fe, Ni, Cu, W, Mo, Ta, U or Co, or a carbide, oxide or nitride comprising at least one of the foregoing metals, or an alloy comprising at least one of the aforementioned materials, or a composite comprising at least one of the aforementioned materials, or a combination of any of the foregoing.

4. The powder compact of claim 1, wherein the particle core material is ductile.

5. The powder compact of claim 1, wherein the dispersed particles further comprise a rare earth element.

6. The powder compact of claim 1, wherein the dispersed particles have an average particle size of about 50 nm to about 500 μm.

7. The powder compact of claim 1, wherein the dispersion of dispersed particles comprises a substantially homogeneous dispersion within the cellular nanomatrix.

8. The powder compact of claim 1, wherein the dispersion of dispersed particles comprises a multi-modal distribution of dispersed particle sizes within the cellular nanomatrix.

9. The powder compact of claim 1, wherein the dispersed particles have an equiaxed particle shape or a substantially elongated particle shape.

10. The powder compact of claim 1, further comprising a plurality of dispersed second particles, wherein the dispersed second particles are also dispersed within the cellular nanomatrix and with respect to the dispersed particles.

11. The powder compact of claim 10, wherein the dispersed second particles comprise Fe, Ni, Cu, Mn or Co, or a carbide, oxide or nitride comprising at least one of the foregoing metals, or an alloy comprising at least one of the aforementioned materials, or a composite comprising at least one of the aforementioned materials, or a combination of any of the foregoing.

12. The powder compact of claim 1, wherein the nanomatrix material comprises Al, Zn, Mn, Mg, Mo, W, Cu, Fe, Si, Ca, Co, Ta, Re or Ni, or an oxide, carbide or nitride thereof, or a combination of any of the aforementioned materials, and wherein the nanomatrix material has a chemical composition and the particle core material has a chemical composition that is different than the chemical composition of the nanomatrix material.

13. The powder compact of claim 1, wherein the cellular nanomatrix has an average thickness of about 50 nm to about 5000 nm.

14. The powder compact of claim 1, wherein the compact is formed from a sintered powder comprising a plurality of powder particles, each powder particle having a particle core that upon sintering comprises a dispersed particle and a single metallic coating layer disposed thereon, and wherein the cellular nanomatrix between adjacent ones of the plurality of dispersed particles comprises the single metallic coating layer of one powder particle, the bond layer and the single metallic coating layer of another of the powder particles.

15. The powder metal compact of claim 1, wherein the compact is formed from a sintered powder comprising a plurality of powder particles, each powder particle having a particle core that upon sintering comprises a dispersed particle and a plurality of metallic coating layers disposed thereon, and wherein the cellular nanomatrix between adjacent ones of the plurality of dispersed particles comprises the plurality of metallic coating layers of one powder particle, the bond layer and plurality of metallic coating layers of another of the powder particles, and wherein adjacent ones of the plurality of metallic coating layers have different chemical compositions.

16. The powder compact of claim 1, wherein the powder compact comprises a plurality of unsintered powder particles.

17. The powder compact of claim 16, wherein the powder compact has a density that is less than a theoretical density of the powder particles.

18. The powder compact of claim 16, wherein the powder compact is formed by a method of uniaxial pressing, isostatic pressing, roll forming, forging, or extrusion at a forming temperature.

19. The powder compact of claim 18, wherein the forming temperature comprises an ambient temperature.

20. The powder compact of claim 1, wherein the powder compact comprises a plurality of sintered powder particles.

21. The powder compact of claim 20, wherein the powder compact has a density that is substantially the same as a theoretical density of the powder particles.

22. The powder compact of claim 20, wherein the powder compact is formed by a method of uniaxial pressing, isostatic pressing, roll forming, forging, or extrusion at a forming temperature.

23. The powder compact of claim 22, wherein the forming temperature is about 20° C. to about 300° C. below a melting temperature of the powder particles.

24. The powder compact of claim 1, wherein the particle core material has a density of about 8.5 g/cm³ or more.

25. The powder compact of claim 1, wherein the particle core material has a density of about 10 g/cm³ or more.
